(19) United States
(12) Patent Application Publication
(10) Pub. No.: US 2016/0173513 A1
(43) Pub. Date: Jun. 16, 2016

(54) APPARATUSES AND METHODS FOR SECURITY IN BROADCAST SERIAL BUSES

(71) Applicant: BATTELLE ENERGY ALLIANCE, LLC., Idaho Falls, ID (US)

(72) Inventors: KENNETH WHITAKER ROHDE, IDAHO FALLS, ID (US); JONATHAN PAUL CHUGG, IDAHO FALLS, ID (US); ASHLEY NICOLE WADE, IDAHO FALLS, ID (US); OLIVER ROBERT REED, IDAHO FALLS, ID (US); BRYCE MERLE WHEELER, IDAHO FALLS, ID (US)

(21) Appl. No.: 14/965,341

(22) Filed: Dec. 10, 2015

Related U.S. Application Data
(60) Provisional application No. 62/090,120, filed on Dec. 10, 2014.

(51) Int. Cl. H04L 29/06

(52) U.S. Cl. CPC H04L 63/1416; H04L 63/1425

(57) ABSTRACT

Apparatuses and methods are disclosed for monitoring broadcast serial communication buses, analyzing communications on those buses, and providing information relative to the monitoring and analysis. A CAN bus is used as an example to provide details of analysis of a broadcast serial bus. Metadata and temporal neighbor history for each type of message identifiers are developed and analyzed. Alerts may be generated if the metadata, the temporal neighbor history, or a combination thereof fall outside predetermined tolerance levels.

### CROSS-REFERENCE TO RELATED APPLICATION

This application claims the benefit of U.S. Provisional Patent Application Ser. No. 62/090,120, filed Dec. 10, 2014, the disclosure of which is hereby incorporated herein in its entirety by this reference.

### TECHNICAL FIELD

Embodiments of the present disclosure relate generally to methods and apparatuses for serial buses. More specifically, embodiments of the present disclosure relate to security analysis of broadcast serial buses.

### BACKGROUND

Broadcast serial buses are used in a variety of applications such as industrial control and communication and automobile communication. These broadcast serial buses are implemented on serial buses where there is not a specific bus master, but multiple masters. In other words, any node on the bus may be a bus master during some periods and a bus slave during other periods. One such broadcast serial bus is a Controller Area Network (CAN) bus, which operates with a low level networking protocol (CAN Bus protocol) used for high-speed broadcast serial data.

However, many of these broadcast serial buses have few if any security measures (e.g., encryption or authentication) defined as part of the bus definition and protocol. As a result, networks using broadcast serial buses may be vulnerable to attack.

### BRIEF SUMMARY

In some embodiments, a security module comprises a bus transceiver for operably coupling to a broadcast serial bus, and a controller operably coupled to the bus transceiver. The controller is configured to monitor communication packets on the broadcast serial bus, analyze message IDs within the communication packets to develop metadata related to the message ID for a network fingerprint of the broadcast serial bus, compare metadata for a present message ID with historical metadata from the network fingerprint for the present message ID to determine if the metadata for the present message ID is outside a tolerance level, detect an anomaly condition if the comparison falls outside the tolerance level, and generate an alert to a user responsive to the anomaly condition being detected.

In some embodiments, a security module comprises a bus transceiver for operably coupling to a broadcast serial bus and a controller operably coupled to the bus transceiver. The controller is configured to monitor communication packets on the broadcast serial bus, analyze the communication packets to develop temporal neighbor history related to individual message IDs of the communication packets, compare a first message ID of a first communication packet to the temporal neighbor history to determine if the first message ID falls outside a tolerance level, and report an anomaly to a user responsive to the comparison falling outside the tolerance level.

In some embodiments, a method for monitoring security of a broadcast serial bus is disclosed. The method comprises monitoring a communication packets on a broadcast serial bus, generating a network fingerprint based on the monitoring including message metadata for the communication packets over time, receiving a first communication packet having a first message ID, determining message metadata for the first communication packet, comparing the message metadata for the first communication packet with the network fingerprint to detect an anomaly, and generating an alert to a user responding to detecting an anomaly.

### BRIEF DESCRIPTION OF THE DRAWING

FIG. 1A is a schematic block diagram of a CAN Bus network including a CAN bus with a security module coupled to the CAN bus.

FIG. 1B is a schematic representation of a message packet for the CAN bus of FIG. 1.

FIG. 2 is a schematic block diagram a computing system that may be used practicing some embodiments of the present disclosure.

FIG. 3 is a pictorial depiction of the security module of FIG. 1A configured to couple to three CAN buses.

FIG. 4 is a pictorial depiction of two example on-board diagnostic modules for a CAN bus.

FIG. 5 is a flow diagram illustrating a process of monitoring and analyzing a CAN bus and developing heuristics for the CAN bus.

FIG. 6 is a flow diagram illustrating a process of developing, monitoring, and analyzing metadata for the CAN bus.

FIG. 7 is a flow diagram illustrating a process of developing, monitoring, and analyzing temporal neighbor information for the CAN bus.

### DETAILED DESCRIPTION

In the following description, reference is made to the accompanying drawings in which is shown, by way of illustration, specific embodiments of the present disclosure. The embodiments are intended to describe aspects of the disclosure in sufficient detail to enable those skilled in the art to practice embodiments of the present disclosure. Other embodiments may be utilized and changes may be made without departing from the scope of the disclosure. The following detailed description is not to be taken in a limiting sense, and the scope of the present invention is defined only by the appended claims.

Furthermore, specific implementations shown and described are only examples and should not be construed as the only way to implement or partition the present disclosure into functional elements unless specified otherwise herein. It will be readily apparent to one of ordinary skill in the art that the various embodiments of the present disclosure may be practiced by numerous other partitioning solutions.

In the following description, elements, circuits, and functions may be shown in block diagram form in order not to obscure the present disclosure in unnecessary detail. Additionally, block definitions and partitioning of logic between various blocks is exemplary of a specific implementation. It will be readily apparent to one of ordinary skill in the art that the present disclosure may be practiced by numerous other partitioning solutions. Those of ordinary skill in the art would understand that information and signals may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative processes, logical blocks, modules, and circuits described in connection with the embodiments disclosed herein may be implemented or performed with control logic such as a general-purpose processor, a special-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein.

A general-purpose processor may be a microprocessor, but the general-purpose processor may also be any processor, controller, microcontroller, or state machine suitable for carrying out processes of the present disclosure. A processor may also be implemented as a combination of computing devices, such as a combination of a DSP and a microprocessor, a plurality of microprocessors, one or more microprocessors in conjunction with a DSP core, or any other such configuration.

A general-purpose processor may be part of a general-purpose computer, which should be considered a special purpose computer when configured to execute instructions (e.g., software code) for carrying out embodiments of the present disclosure. Moreover, when configured according to embodiments of the present disclosure, such a special-purpose computer improves the function of a general-purpose computer because, absent the present disclosure, the general-purpose computer would not be able to carry out the processes of the present disclosure. The present disclosure also provides meaningful limitations in one or more particular technical environments that go beyond an abstract idea. For example, embodiments of the present disclosure provide improvements in the technical field of monitoring communication buses, analyzing communication buses, and providing information relative to the monitoring and analysis.

In addition, it is noted that the embodiments may be described in terms of a process that may be depicted as a flowchart, a flow diagram, a structure diagram, or a block diagram. Although a process may describe operational acts as a sequential process, many of these acts can be performed in another sequence, in parallel, or substantially concurrently. In addition, the order of the acts may be rearranged. A process may correspond to a method, a function, a procedure, a subroutine, a subprogram, etc. Furthermore, the methods disclosed herein may be implemented in hardware, software, or both. If implemented in software, the functions may be stored or transmitted as one or more computer-readable instructions (e.g., software code) on a computer-readable medium. Computer-readable media includes both computer storage media and communication media including any medium that facilitates transfer of a computer program from one place to another.

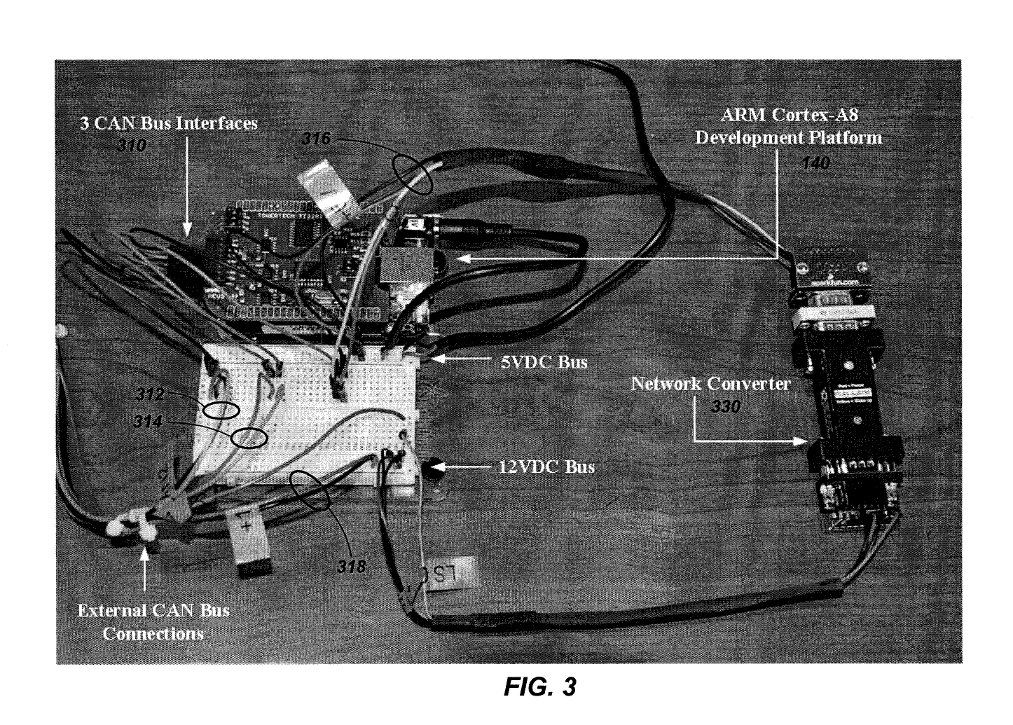

Elements described herein may include multiple instances of the same element. These elements may be generically indicated by a numerical designator (e.g. 110) and specifically indicated by the numerical indicator followed by an alphabetic designator (e.g., 110A) or a numeric indicator preceded by a “dash” (e.g., 110-1). For ease of following the description, for the most part element number indicators begin with the number of the drawing on which the elements are introduced or most fully discussed. For example, where feasible elements in FIG. 3 are designated with a format of 3xx, where 3 indicates FIG. 3 and xx designates the unique element.

It should be understood that any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed or that the first element must precede the second element in some manner. In addition, unless stated otherwise, a set of elements may comprise one or more elements.

Embodiments of the present disclosure include devices and methods for monitoring broadcast serial communication buses, analyzing communications on those buses, and providing information relative to the monitoring and analysis. Embodiments include executable software configured to run on a platform to monitor the broadcast serial communication network to which the monitoring device is connected. Specific applications of such networks and buses include the industries in the transportation sector, such as the automobile industry (e.g., in-vehicle networks), or other applications such as maritime, locomotives, and aviation. Other applications (e.g., industrial control systems) are also contemplated that use broadcast serial control buses for communicating between different devices (e.g., programmable logic controllers (PLCs), field devices, etc.). A device according to an embodiment herein may be purchased to run on any vehicle, or for a specific vehicle, to monitor a CAN Bus network for potential intrusion or compromise.

A broadcast serial bus is generally defined as a multi-master serial bus wherein the protocol on the broadcast serial bus is determined by packets that are broadcast from the present master on to the broadcast serial bus. Each packet includes a message identifier (message ID) and data associated with the message ID. In general, all devices on the broadcast serial bus may listen to, and interpret, the message ID and the data associated with the message ID of the packet. In order to give details of form and function for embodiments of the present disclosure, much of the discussion presented herein relates to the CAN bus as one type of broadcast serial bus. However, embodiments of the present disclosure may be used with other types of broadcast serial buses, such as, for example, Profibus (Process Field Bus) and Modbus. In many instances, CAN buses are used in automobiles and other buses such as Profibus and Modbus are used in industrial control applications.

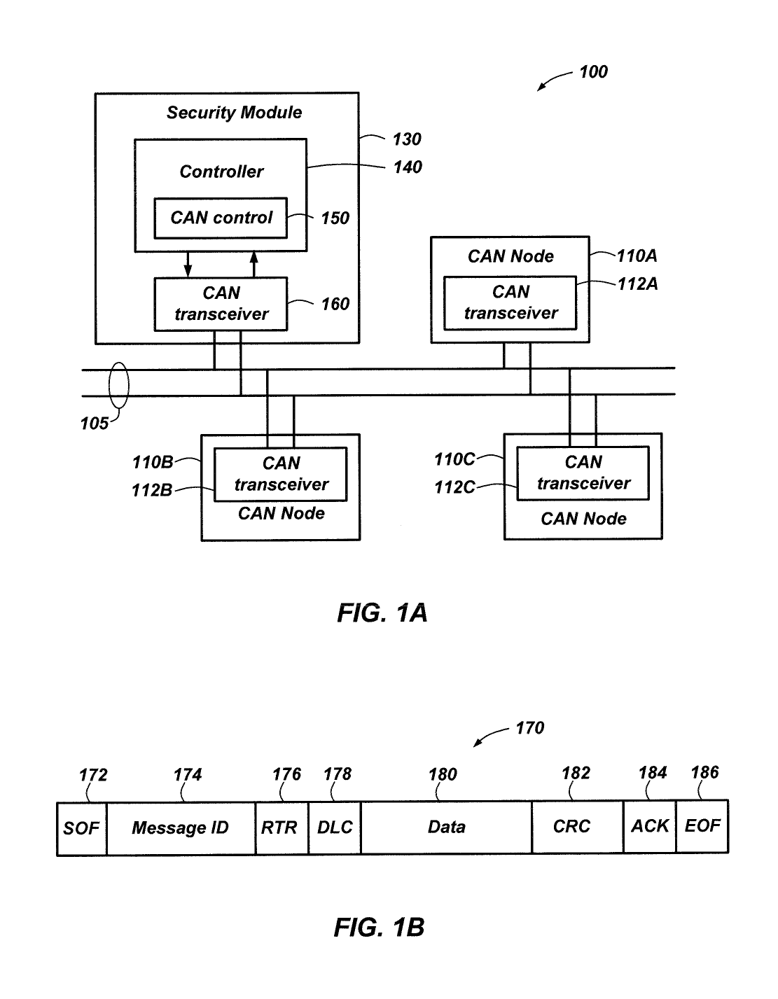

FIG. 1A is a schematic block diagram of a CAN Bus network 100 including a CAN bus 105 with a security module 130 coupled to the CAN bus 105. The CAN bus 105 is configured as a multi-master serial bus standard for connecting Electronic Control Units (ECUs) referred to herein as nodes 110A, 110B, 110C (also referred to collectively as “nodes 110”). The security module 130 is also considered a node. Two or more nodes 110 are implemented on the CAN Bus network 100 to communicate. The complexity of any given node 110 may range from a complex embedded computer or microcontroller to a simple I/O device. The nodes 110 may also be configured as a gateway to another computer or communication device via another type of communication interface, such as, for example, Ethernet, WiFi, Universal Serial bus, and cellular telephone networks.

The nodes 110A, 110B, and 110C may include CAN transceivers 112A, 112B, and 112C, respectively (also referred to collectively as “CAN transceivers 112”). The CAN transceivers 112 are configured to develop proper voltage levels and timing for interfacing to the CAN bus 105. Each node 110 may be configured to perform some type of processing for receiving packets from the CAN bus 105 and the CAN transceivers 112.

The security module 130 may also include a CAN transceiver 160 configured to interface to the CAN bus 105 similar to the CAN transceivers 112 of the nodes 110. The security module 130 also includes a controller 140 configured to implement CAN control processes 150 along with other processes for embodiments of the present disclosure.

In a CAN protocol, each node 110 including the security module 130 may be able to send and receive messages as packets of data. Multiple nodes 110 may attempt to send a packets at the same time, and the CAN protocol includes an arbitration process to determine which node 110 becomes the master for the current packet being transmitted.

FIG. 1B is a schematic representation of a message packet 170 for the CAN bus 105 of FIG. 1. Other types of broadcast serial buses may include similar fields as will be apparent to those of ordinary skill in the art. The message packet 170 includes a Start-Of-Frame (SOF) indicator 172, a message identifier 174 (also referred to herein as “message ID 174”), a Remote Transmission Request (RTR) indicator 176, and a Data Length Code (DLC) 178. The message packet 170 also includes a data field 180, a Cyclic Redundancy Check (CRC) field 182, an acknowledge (ACK) field 184, and an End-Of-Frame (SOF) indicator 186.

Most of these fields will be clear to those of ordinary skill in the art and need not be described in detail. For the most part, embodiments of the present disclosure are concerned with the message ID 174 and the data field 180. The message ID 174 may be defined such that the lower the value of the message ID 174, the higher the priority for the message packet 170 on the CAN bus 105 during the arbitration process. For example, a message ID 174 with a higher priority will win the arbitration process and gain control of the CAN bus 105 for the duration of the message packet 170.

In the arbitration process, any node 110 that wants to become a master transmits a bit and also listens to the CAN bus 105 to see what bit is present on the bus. For example, the most significant bit is transmitted first to determine which of the nodes 110 has priority as the master. The arbitration process may define a logic 1 as a “recessive” bit, and a logic 0 as a “dominant” bit in that the dominant bit wins in the event of a potential conflict.

As an example, if a logic 1 is transmitted by all potential masters, then a logic 1 is seen by all nodes 110 (including the transmitting node and the receiving nodes). If a logic 0 is transmitted by all potential masters, then a logic 0 is seen by all the nodes 110. However, if a logic 1 is transmitted by one or more nodes, and a logic 0 is transmitted by one or more nodes, the CAN bus 105 may be configured such that the logic 0 dominates, and a logic 0 is seen by all the nodes 110. When a potential bus master transmits a logic 1 for the present bit, but then sees a logic 0 for the present bit, the potential master knows it has lost the arbitration and discontinues transmission for the rest of the message packet 170. As a result, any node 110 that transmits the first logic 1 loses arbitration and re-queues its message for later transmission. This process continues throughout the duration of the message ID 174 portion. In the CAN bus protocol, each message ID 174 is defined as unique so that the arbitration process will complete with a single potential bus master taking control of the bus for the duration of the message packet 170. Any losing potential bus masters then queue their packet and attempt to send it during the arbitration cycle of the next message packet 170 in an attempt to win the arbitration and send its message.

CAN bus 105 networks may be found in many control system environments, but the CAN bus 105 is most commonly thought of and recognized in the automobile industry. Conventional CAN Bus networks typically do not provide built-in security features and rely upon the higher level protocol implementers to create security features such as authentication or encryption. Due to the lack of security mechanisms in the CAN bus 105, embodiments of the present disclosure create a hardware device (e.g., configured to execute software processes) that will attach to the CAN bus 105 network and monitor the network for abnormal (e.g., hostile) conditions. The end user (e.g., an automobile driver) can then be alerted to the abnormal conditions that may indicate a hostile presence on the network.

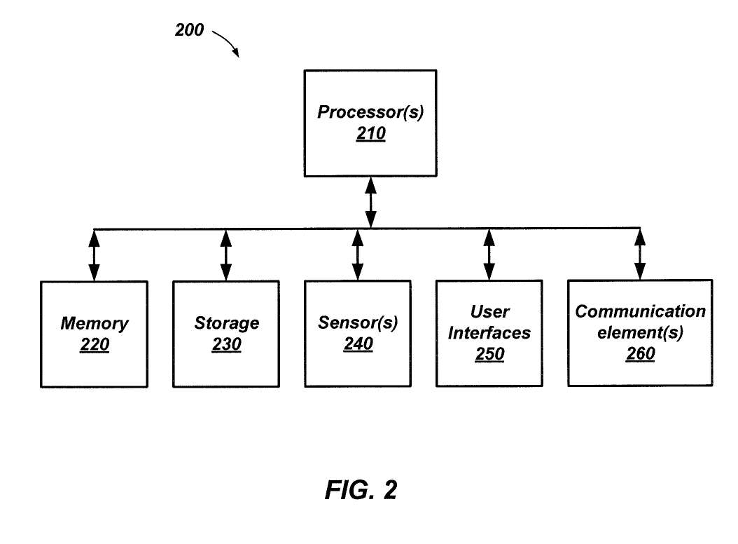

FIG. 2 is a computing system 200 for practicing embodiments of the present disclosure. The computing system 200 may be the controller 140 of FIG. 1A or other type of computer. The terms of controller, microcontroller, control circuit, computer, computing system, and server may be used interchangeably herein to indicate a system for practicing embodiments of the present disclosure. The computing system 200 may include one or more processors 210, memory 220, storage 230, sensors 240, user interfaces 250, and one or more communication elements 260.

As non-limiting examples, the computing system 200 may be a user-type computer, a file server, a compute server, a notebook computer, a tablet, a handheld device, a mobile device, or other similar computer system for executing software.

The one or more processors 210 may be configured for executing a wide variety of operating systems and applications including the computing instructions for carrying out embodiments of the present disclosure.

The memory 220 may be used to hold computing instructions, data, and other information for performing a wide variety of tasks including performing embodiments of the present disclosure. By way of example, and not limitation, the memory 220 may include Synchronous Random Access Memory (SRAM), Dynamic RAM (DRAM), Read-Only Memory (ROM), Flash memory, and the like.

Information related to the computing system 200 may be presented to, and received from, a user with the one or more user interfaces 250. As non-limiting examples, the user interfaces 250 may include elements such as displays, keyboards, mice, joysticks, haptic devices, microphones, speakers, cameras, and touchscreens. A display on the computing system may be configured to present a graphical user interface (GUI) with information about the embodiments of the present disclosure, as is explained below.

The communication elements 260 may be configured for communicating with other devices or communication networks. As non-limiting examples, the communication elements 150 may include elements for communicating on wired and wireless communication media, such as for example, one or more broadcast serial buses, serial ports, parallel ports, Ethernet connections, universal serial bus (USB) connections IEEE 1394 (“firewire”) connections, Bluetooth wireless connections, 802.1 a/b/g/n type wireless connections, cellular connections, and other suitable communication interfaces and protocols.

The storage 230 may be used for storing relatively large amounts of non-volatile information for use in the computing system 200 and may be configured as one or more storage devices. By way of example, and not limitation, these storage devices may include computer-readable media (CRM). When executed as firmware or software, the instructions for performing the processes may be stored on the CRM. A computer-readable medium includes, but is not limited to, magnetic and optical storage devices such as disk drives, magnetic tape, CDs (compact discs), DVDs (digital versatile discs or digital video discs), and semiconductor devices such as RAM, DRAM, ROM, EPROM, and Flash memory.

Software processes illustrated herein are intended to illustrate representative processes that may be performed by the systems illustrated herein. Unless specified otherwise, the order in which the process acts are described is not intended to be construed as a limitation, and acts described as occurring sequentially may occur in a different sequence, or in one or more parallel process streams. It will be appreciated by those of ordinary skill in the art that many steps and processes may occur in addition to those outlined in flow charts. Furthermore, the processes may be implemented in any suitable hardware, software, firmware, or combinations thereof.

By way of non-limiting example, computing instructions for performing the processes may be stored on the storage 230, transferred to the memory 220 for execution, and executed by the processors 210. The processors 210, when executing computing instructions configured for performing the processes, constitutes structure for performing the processes and can be considered a special-purpose computer that enhances the function of the computer when so configured. In addition, some or all portions of the processes may be performed by hardware specifically configured for carrying out the processes.

FIG. 3 is a pictorial depiction of the security module of FIG. 1A configured to couple to three CAN buses 310. This embodiment is configured with an Acorn RISC Machine (ARM) Cortex-A8 development platform 140 running a custom Linux kernel. Logic was added to the development platform to provide 3 CAN network interfaces 312, 314, and 316. This embodiment also include a network converter 330 on one of the CAN interfaces 316 to convert it to another CAN bus interface 318 so that support for two-wire high-speed CAN networks, two-wire low-speed CAN networks, and single-wire low-speed CAN networks are available.

Executable instructions (e.g., software) is configured to run on the ARM platform 140 to monitor the CAN network(s) to which it is connected. These instructions may be configured to perform different heuristics operations to “fingerprint” the network during normal operations (e.g., traffic). The terms “fingerprint” and “fingerprinting” are also referred to herein as “characteristics” and “characterization,” respectively. As will be discussed more fully below, the CAN network fingerprint may be based at least in part on the following information: (1) message metadata, and (2) message temporal neighbor information. Continual analysis of these datasets allows a fingerprint to be generated for the CAN bus 105 and also allows identification of a substantial change in the fingerprint. When a fingerprint has been altered, an alert may be generated for the user.

Additional log information may also be generated when the network communications significantly change, as identified by the monitoring and characterization processes of the CAN buses 105. Other defensive capabilities may include a processes configured to take action responsive to detecting a network anomaly (e.g., an intrusion, an exploitation attempt, etc.), such as, for example, by presenting information identifying the anomaly to a user through a user interface. By way of non-limiting example, the anomaly may be presented by a tactile indicator, an audible indicator, a visual indicator, or combinations thereof. In automobile applications, presentation of the anomaly may include presenting an audible alarm through speakers (e.g., the built-in automobile speakers), presenting visual warnings on a dashboard or other display, or vibrating a steering wheel. In industrial control applications, presentation of the anomaly may include presenting an audible alarm through speakers and/or presenting visual warnings with flashing lights, messages on user displays, or combinations thereof.

The instructions may cause the processor to automatically negotiate network speed settings (e.g., baud rate) as well as perform some automatic detection of the network type (e.g., high-speed or low-speed) and any higher level protocols being used. The automatic profiling may allow the prototype device to be used in various vehicles and on Industrial Control Systems (e.g., using DeviceNet, Profibus, Modbus, etc.).

The instructions may also cause the processor to monitor and characterize custom protocols at higher levels than the CAN bus 105. A non-limiting example of a higher level protocol includes the General Motors (GM) GMLAN protocol running on the CAN bus 105. With these other protocols, embodiments of the present disclosure may be configured to better interpret the meaning of the network messages and not just watch for patterns. Some of the features may include the ability to change/alter messages that the user (driver) does not want stored in the vehicle modules (e.g., Engine Control Module, Telemetry Control Module, Body Control Module) such as GPS position information, vehicle speed, etc. In other words, once the system understands the message contents for a specific platform (e.g., GM), the software may be enhanced to include the ability for a user to determine what metadata (e.g., vehicle speed, GPS position, etc.) is generated and stored. This will allow the prototype to act as a privacy unit for an end user.

As a non-limiting example, embodiments may be configured to recognize GPS messages or speed messages. Alteration processes may then be employed to prevent the message from completing by writing a higher priority message, modifying the data, or creating confusing data. For example, if there are repeated GPS messages indicating the present location as New York, additional GPS messages may be generated indicating another location (e.g., Los Angeles) to create confusion in recipients of GPS messages.

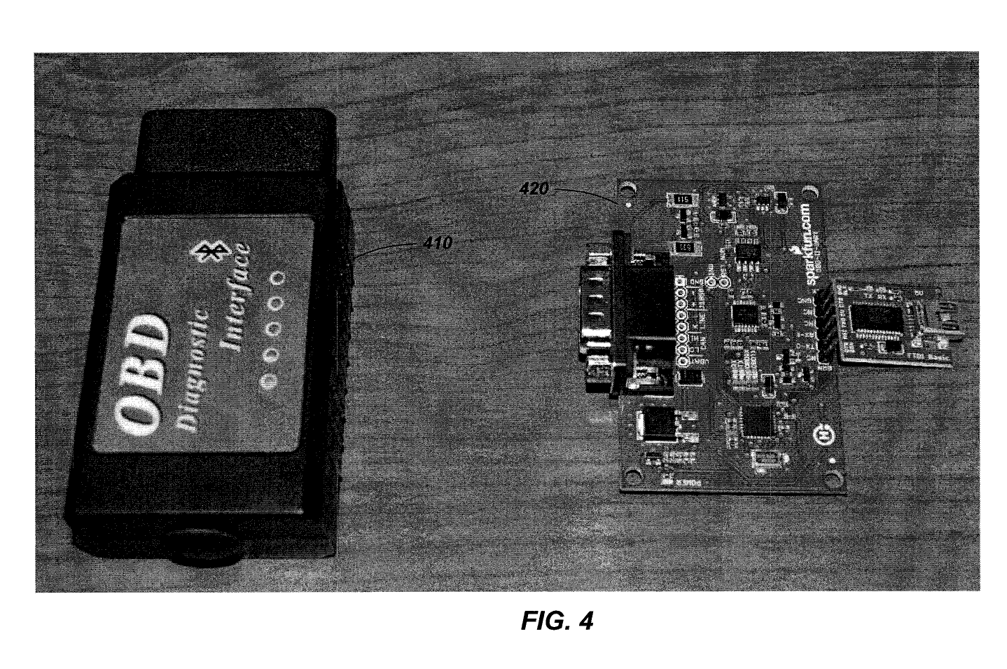

Embodiments such as the system of FIG. 3 may be reduced in size to resemble other on-board diagnostic modules for the CAN bus 105. For example, FIG. 4 is a pictorial depiction of two example on-board diagnostic modules (410 and 420) for a CAN bus. These small modules are shown as a representation of how small hardware can be customized into a very easy to use device that may be quickly plugged into a CAN Bus network to monitor the CAN Bus network. As a result, the safety and security of the CAN Bus network may be enhanced and improved by detecting anomalies, potential intrusions, and/or exploitation attempts on the CAN Bus network.

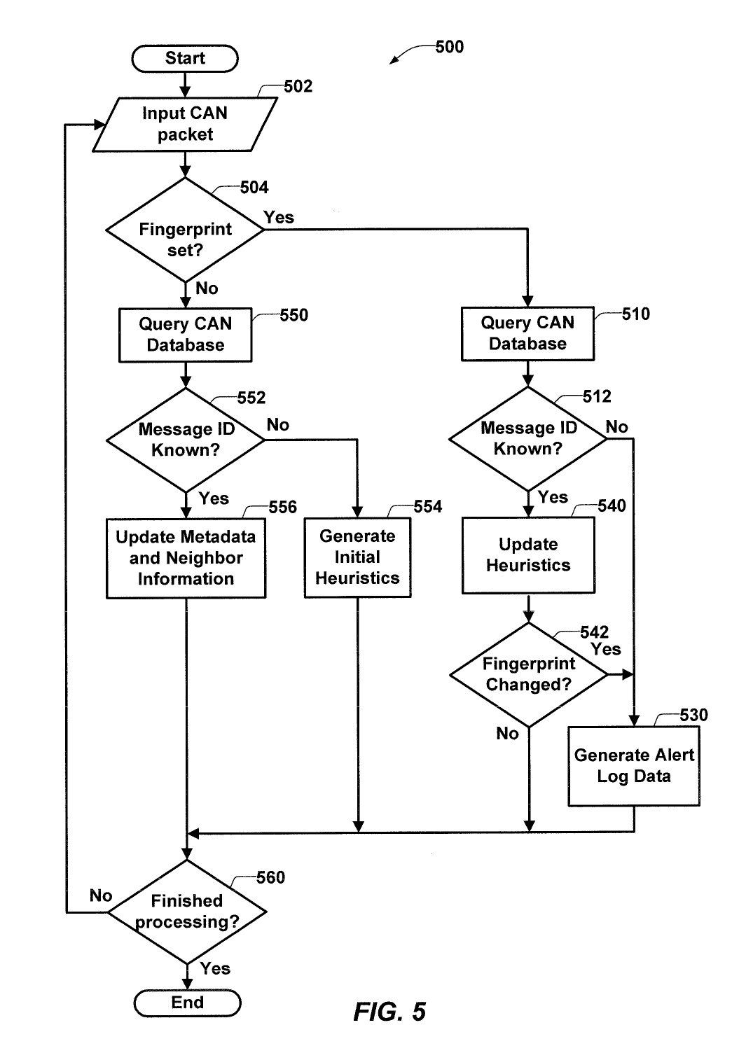

FIG. 5 is a flow diagram 500 illustrating a process of monitoring and analyzing a CAN bus and developing heuristics for messages on a CAN bus. The software developed for use on the security module 130 implements processes for tracking the CAN Bus network by monitoring each CAN interface individually. When monitoring a CAN interface, messages may be received and processed as packets for further analysis according to the process of the flow diagram 500 of FIG. 5.

While the CAN Bus network(s) are monitored, the heuristics for the CAN Bus network are updated and thus generate an overall fingerprint for the CAN Bus network. As discussed above, the network fingerprint may be based in part on: (1) message metadata, and/or (2) message temporal neighbor information. Continual analysis of these datasets allows a network fingerprint to be generated for the CAN bus 105. Once a fingerprint for the CAN Bus network has been established (e.g., either automatically or through user input), the messages may be analyzed to determine if the network fingerprint has changed. Detecting an alteration of the network fingerprint may cause an alert condition to be generated, and the data associated with the alteration may be processed and logged.

At operation 502, a new CAN packet may be input by a node on the CAN bus 105 for processing. For this example, it is assumed that the arbitration process described above has already occurred to resolve the appropriate message being transmitted by the appropriate node. The CAN packet may include the data and fields described above with respect to FIG. 1B. In particular, the CAN packet may include the present message ID, a data field, as well as other fields.

At operation 504, it is determined if a network fingerprint for the CAN Bus network has already been set (i.e., established). In some embodiments, the network fingerprint may be set automatically by the system after a sufficient amount of time has passed for the CAN database to have a reliable set of data for normal operations of the CAN Bus network. In some embodiments, the decision for when to set the network fingerprint may be performed manually by a user. In either situation, the system may continually monitor and log data for the CAN Bus network in order to gather the samples over time until an initial network fingerprint is set. In other words, at operation 504, if a fingerprint for the CAN Bus network is not set, operations 550, 552, 556, and 560 continuously update the data used for building the network fingerprint until the network fingerprint is defined as being “set” (e.g., a flag value may be set that is checked by the system at each iteration of operation 504).

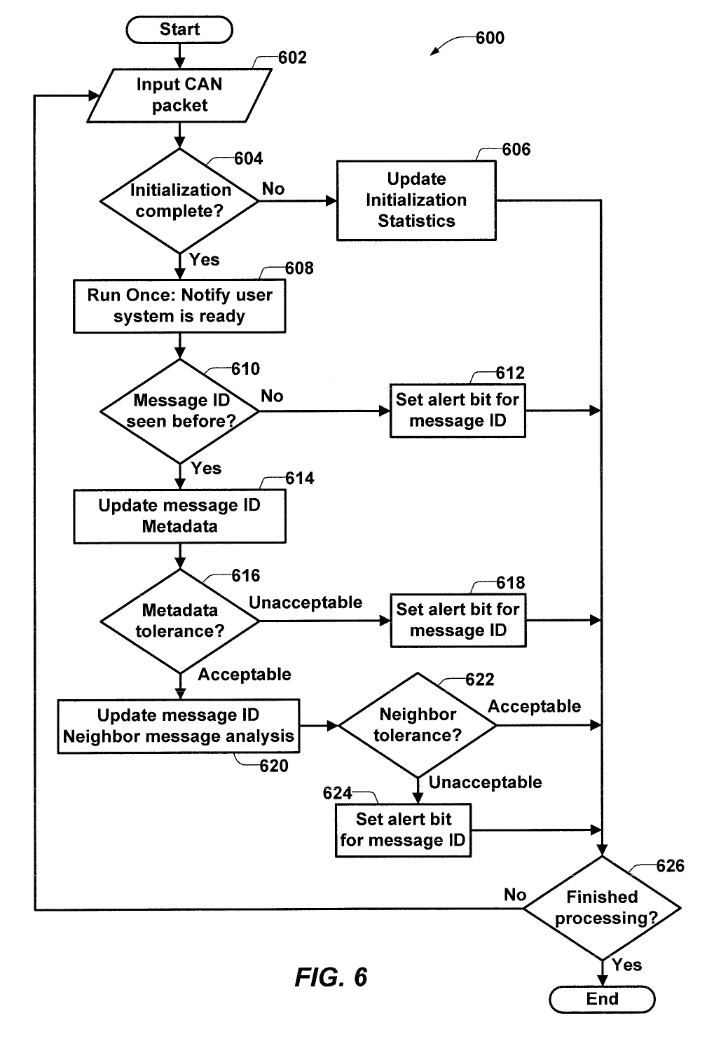

At operation 550, the CAN database may be queried to find information related to the present message ID for the CAN packet being analyzed. At operation 552, it is determined if the present message ID of the CAN packet is known. Determining if the present message ID is known may be based on the information retrieved from the query of the CAN database. If the present message ID is not known, operation 554 indicates that heuristics related to the present message ID are generated. If, on the other hand, the present message ID for the CAN packet is known, operation 556 indicates that metadata and temporal neighbor information for the present message ID of the CAN packet are updated, as will be described in detail below with reference to FIG. 6. After the heuristics are generated (operation 554), or the metadata and temporal neighbor information (operation 556) for the present message ID are updated, the process may continue to operation 560 to determine if processing is finished.

If it is determined that the network fingerprint for the CAN Bus network is set at operation 504, operation 510 indicates that the CAN database may be queried to find information related to the present message ID of the CAN packet being analyzed. At operation 512, it is determined if the present message ID for the CAN packet is known. Determining if the present message ID is known may be based on the information retrieved from the query of the CAN database. If the present message ID is not known, operation 530 indicates that an alert may be generated and the data (including the message ID) may be logged for the present CAN packet. If, on the other hand, the present message ID is known, operation 540 indicates that the heuristics related to the present message ID are updated. Operation 542 indicates that a test is performed to determine if the fingerprint for the present message ID has changed. The test may include comparing metadata for the message with the fingerprint data associated with the particular message ID for the present CAN packet. If the fingerprint has changed, operation 530 indicates that an alert may be generated and the data logged. The process then moves to operation 560 to determine if processing is finished as described above. If the fingerprint has not changed, the process may transition directly (i.e., without generating an alert/logging data) from operation 542 to operation 560 to determine if processing is finished as described above.

FIG. 6 is a flow diagram illustrating a process 600 of developing, monitoring, and analyzing metadata for messages on the CAN bus. Metadata that may be stored and analyzed may include, but is not limited to: message count, message frequency, data length history, data content history, protocol content for a specific higher level protocol (e.g., GMLAN), etc.

The message count may be configured as a totalizer field of the number of CAN packets the system started processing the CAN packets or other defined period of time. A message count may also be tracked for a total number of CAN packets received for a particular message ID since the processing began or for another defined period of time.

The message frequency may be configured to define a real value generated by dividing the number of CAN packets received for a particular message ID by the total number of CAN packets received during a period of time. Message frequency may be tracked for different time periods and compared to comparable time periods (e.g., neighboring time periods, similar times of day, etc.) to determine if the message frequency has changed significantly in comparison with the frequency of the message ID during the other time period (e.g., frequency may be compared for two consecutive time periods). The observation period is determined by the speed of the network (e.g. baud rate/bandwidth) as well as network saturation levels. That is to say, the observation period may be short (e.g., on the order of seconds) for high speed/high utilization networks compared to the slower (e.g., on the order of minutes) for less saturated/slower networks.

The data length history may be configured to track the message data length (e.g., 1 . . . n) as a historical value. Messages either: 1) transmit the same number of bytes in each CAN packet, or 2) transmit a variable number of bytes. For example, CAN packets having a first message ID may be expected to have a data field with the same data length (e.g., 8 bytes) each time a new CAN packet is received having the first message ID. The behavior of CAN packets for the first message ID changing from one data length (e.g., always 8 bytes) to another data length (e.g., 1 byte, 200 bytes, etc.) may indicate an anomaly condition causing the system to generate an alert.

The data content history may be configured to recognize that some CAN packets will contain data content that is similar to other CAN packets having the same message ID. Other CAN packets associated with other message IDs may contain data content that may appear random or cyclical. As a result, monitoring the history of the data contents allows alert decisions to be based upon a change of the data content type.

As an example, a first message ID may consistently be associated with data content that is consistently the same over time. If a CAN packet is received that has the first message ID along with data content that is different than what is historically associated with the first message ID, the system may identify an anomaly condition and generate an alert.

As another example, the network fingerprint may identify that the second message ID is associated consistently with multiple types of data content. As a result, the system may identify multiple different “buckets” of data content (e.g., bucket X, bucket Y, bucket Z) that are historically associated with the second message ID. If a new CAN packet is received that has the second message ID along with data content W that falls outside of buckets X, Y, Z, the system may identify an anomaly condition and generate an alert.

As another example, a third message ID may be associated with data content that is consistently cyclical over time. For example, if a CAN packet is received that has the third message ID along with data content that has a consistent pattern over time. In other words, a pattern may include data content A, then data content B, then data content C that repeats over time. Receiving data content D with the third message ID that is not part of the pattern, or data content A, B, C in a position that is out of order in the pattern may cause the system to identify an anomaly condition and generate an alert.

As yet another example, a fourth message ID may be associated with data content that is relatively random over without any particular pattern or other repeated data content. If CAN packet are received that are detected to repeat in a manner that is unexpected for the fourth message ID, then the system may detect an anomaly condition and generate an alert.

Returning to FIG. 6, at operation 602 a new CAN packet may be received to be processed. Operation 604 indicates that a test is performed to see if initialization for this CAN packet is complete. If not, operation 606 indicates the initialization statistics related to the present message ID are updated. The process then moves to operation 626 to determine if the processing is finished. If the processing is finished, the process ends. If processing is not finished, the process returns to operation 602 to receive a new CAN packet.

Returning to operation 604, if initialization is complete, operation 608 indicates that the user is notified that the system is ready. Note that the initialization process may need to be only be performed the first time through and can be skipped in subsequent processing of other CAN packets. Operation 610 indicates that a test is performed to determine if the present message ID has been seen before by the system. If the present message ID is a new message ID, an alert bit may be set for the particular message ID at operation 612. The process then moves to operation 626 to determine if processing of CAN packets is finished as described above.

Returning to operation 610, if the present message ID has been seen before, operation 614 updates the metadata for the present message ID. At operation 616, the metadata may be analyzed to determine if the metadata is within predetermined tolerance levels for the network fingerprint. If the metadata is unacceptable (i.e., outside of the tolerance level), operation 618 indicates that an alert bit may be set for the present message ID. The process then continues on to operation 626 to determine if processing is finished as described above.

Metadata tolerance levels are determined to be acceptable so long as the new calculated values are within a percentage of previously observed values. The percentages are calculated after an initial observation period (i.e. learning time) in which the common behavior of the network is determined. The particular percentage may depend on the particular category of metadata being applied. For example, the tolerance level used to determine whether the data length of the CAN packet is unacceptable may be different than the tolerance level used to determine if the frequency of the present message ID of the CAN packet is unacceptable.

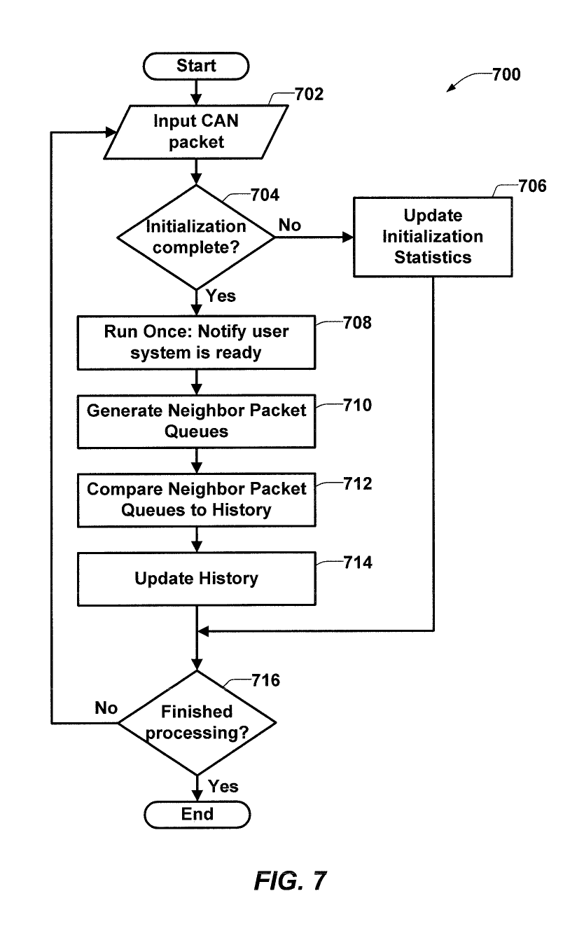

Returning to operation 616, if the metadata tolerance levels are acceptable, operation 620 indicates that the neighbor message analysis for the present message ID may be performed. For example, several message IDs are generally seen broadcast around the same time as companion message IDs. The neighbor message analysis process keeps a history of preceding and subsequent message IDs observed around a specific CAN ID message. Details of the process of operation 620 are described below with reference to FIG. 7.

At operation 622, the system may determine if the neighbor message analysis produced information that is within predetermined tolerance levels. The tolerance level may be calculated during the initialization of the neighbor message analysis process and then checked each time a new CAN packet is received for processing. If the tolerance level is unacceptable, operation 624 indicates that an alert bit may be set for the present message ID. The process then moves to operation 626 to determine if processing is finished as described above. If the tolerance level is acceptable the process can move directly to operation 626.

FIG. 7 is a flow diagram illustrating a process 700 of developing, monitoring, and analyzing temporal neighbor information for the CAN bus for the CAN Bus network. The process begins at operation 702, which indicates that a new CAN packet is input by a node and received on the CAN bus for processing. Operation 704 indicates that a test is performed to see if initialization for this CAN packet is complete. If initialization for the CAN packet is not complete, operation 706 indicates the initialization statistics related to the present message ID are updated. The process then moves to operation 716 to determine if processing of the messages on the CAN bus is finished. If so, the process ends. If processing of the messages on the CAN bus is not finished, the process returns to operation 702 to receive a new CAN packet.

During initialization at operation 706, the system builds a history of neighboring messages that were received prior to the present message ID as well as those received after the current present ID. The predecessor and successor messages are kept in message queues so that statistics can be generated regarding what messages are typically observed in these two queues. The messages queues are also analyzed for patterns and other statistics such as data length and data content.

As a non-limiting example, temporal neighbor analysis can be observed in the remote start functionality of a modern vehicle using a remote key fob. When a user wishes to start a vehicle from the remote key fob, the user first presses the lock button on the remote key fob followed by pressing and holding the remote start button for about 2 seconds. This set of actions may generate hundreds of CAN packets on the vehicle CAN Bus Network to: (1) authenticate the key fob, (2) ensure the vehicle is locked, (3) receive the initial remote start message, (4) determine the button was held for 2 seconds, and (5) send the messages to start the engine. The neighbor analysis initialization will monitor what messages (based on message IDs) were generated during this process and keep a history of those messages so that they can be used for comparison at a later time when another remote start action is received.

Returning to operation 704, if initialization is complete, operation 708 indicates that the user is notified that the system is ready. Note that this process may only need to be performed the first time through and can be skipped in subsequent processing. At operation 710, queues may be generated for temporal neighbor CAN packets for the present CAN packet. Temporal neighbors may include CAN packets that immediately preceded the present CAN packet and CAN packets that immediately follow the present CAN packet. The queues may be of varying depth depending on the application and the type of action to be taken. As a non-limiting example the message queues may be between 2 and 10 CAN packets preceding the present CAN packets and 2 and 10 messages subsequent to the present CAN packets.

When a CAN packet is processed, the message ID may be used in two sub processes. First, the present message ID may be added to the successor message queue for the previously received message. The previously received message ID may then be analyzed. Second, the present message may also analyzed by looking at its predecessor message queue. Both of these message queues are updated with the current message IDs before the history comparison proceeds.

Operation 712 indicates that the temporal neighbor packet queues for the present message ID are compared to a history of the packet queues. This comparison is then used in operation 622 discussed above with reference to FIG. 6, which determines if the tests are within a predetermined tolerance.

When a CAN packet is received, that message ID may be used in three ways: (1) the message ID may be directly examined to determine the state of its message queues (e.g., predecessor and successor message queues), (2) the message ID may be added to the successor queue of the previously received message, and (3) the message ID may be added to a processing queue to be processed during the next analysis cycle as the new previous message.

During step (1) the message ID is examined to determine what has historically been received as preceding messages ID, and that history is compared to the current predecessor message queue. Any drastic changes in the predecessor messages IDs will generate an alert. During step (3) the message ID is added to the successor queue of the previously received message ID, and then the previous message's successor message queue is examined and compared to the historical successor message queue. The historical message queues (e.g., both predecessor and successor message queues) are generated during neighbor history initialization.

Operation 714 indicates that the history for the present message ID is updated. The predecessor and successor message queues for a message ID are periodically updated during runtime. This allows for the history to have a baseline that was created during initialization, but that baseline can be updated due to changing network conditions. A good example of this situation may include a change in driving conditions (dry to snow) where a modern vehicle may change vehicle wide settings, or due to changes in a vehicle evoked by the driver (e.g., disabling traction control). The process then moves to operation 716 to determine if processing is finished as described above.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

What is claimed is:

1. A security module, comprising:
a bus transceiver for operably coupling to a broadcast serial bus; and
a controller operably coupled to the bus transceiver, the controller configured to:
monitor communication packets on the broadcast serial bus;
analyze message IDs within the communication packets to develop metadata related to the message ID for a network fingerprint of the broadcast serial bus;
compare metadata for a present message ID with historical metadata from the network fingerprint for the present message ID to determine if the metadata for the present message ID is outside a tolerance level;
detect an anomaly condition if the comparison falls outside the tolerance level; and
generate an alert to a user responsive to the anomaly condition being detected.

2. The security module of claim 1, wherein the metadata includes one or more parameters selected from the group consisting of a message count, a message frequency, a data length history, data content history, neighbor data, and protocol content for a specific higher level protocol.

3. The security module of claim 1, wherein the controller is further configured to maintain a predecessor message queue containing message IDs for a number of communication packets immediately preceding the present message ID.

4. The security module of claim 1, wherein the controller is further configured to maintain a successor message queue containing message IDs for a number of communication packets immediately following the present message ID.

5. The security module of claim 1, wherein the broadcast serial bus is selected from the group consisting of a controller area network (CAN) bus, a Process Field Bus (Profibus) and a Modbus.

6. The security module of claim 1, wherein the anomaly condition indicates at least one of a network intrusion or a network exploitation by an unauthorized user.

7. The security module of claim 1, wherein the controller is further configured to update the network fingerprint over time as network conditions change or as new message IDs are identified for received communication packets.

8. A security module, comprising:
a bus transceiver for operably coupling to a broadcast serial bus; and
a controller operably coupled to the bus transceiver, the controller configured to:
monitor communication packets on the broadcast serial bus;
analyze the communication packets to develop temporal neighbor history related to individual message IDs of the communication packets;
compare a first message ID of a first communication packet to the temporal neighbor history to determine if the first message ID falls outside a tolerance level; and
report an anomaly to a user responsive to the comparison falling outside the tolerance level.

9. The security module of claim 8, wherein the temporal neighbor history includes a predecessor queue for messages preceding the first message ID and a successor queue for messages subsequent to the first message ID.

10. The security module of claim 9, wherein each of the predecessor queue and the successor queue each include entries for message IDs within a range between two to ten communication packets.

11. The security module of claim 8, wherein the broad case serial bus is a controller area network (CAN) bus and the communication packets are CAN packets.

12. A method for monitoring security of a broadcast serial bus, the method comprising:
monitoring a communication packets on a broadcast serial bus;
generating a network fingerprint based on the monitoring including message metadata for the communication packets over time;
receiving a first communication packet having a first message ID;
determining message metadata for the first communication packet;
comparing the message metadata for the first communication packet with the network fingerprint to detect an anomaly; and
generating an alert to a user responding to detecting an anomaly.

13. The method of claim 12, wherein determining message metadata for the first communication packet includes determining a message frequency for a percentage of time that communication packets having the first message ID is received over an observation period.

14. The method of claim 13, further comprising determining the observation period based at least in part on at least one of a speed of communication or a saturation level on the broadcast serial bus.

15. The method of claim 12, wherein determining message metadata for the first communication packet includes determining a data length for a data field of the first communication packet that is used to compare with a data length history for the communication packets over time that also have the first message ID.

16. The method of claim 12, wherein determining message metadata for the first communication packet includes determining a data content for a data field of the first communication packet that is used to compare with data content history for the communication packets over time that also have the first message ID.

17. The method of claim 16, wherein the data content history is divided into data content buckets of similar groups of data content that is sent using the first message ID.

18. The method of claim 12, wherein determining message metadata for the first communication packet includes:
determining a higher level protocol specific to a platform implementing for the broadcast serial bus; and
identifying whether protocol content is present within the first communication packet that is unique to the higher level protocol to detect the anomaly responsive to the protocol content not being present within the first communication packet.

19. The method of claim 18, wherein the platform implementing the broadcast serial bus is selected from the group consisting of a land vehicle platform, a maritime vehicle platform, a locomotive platform, an aviation platform, and an industrial control system platform.

20. The method of claim 12, wherein determining message metadata for the first communication packet includes maintaining a temporal neighbor history including a predecessor queue for messages preceding the first communication packet and a successor queue for messages subsequent to the first communication packet.
